(19) United States
(12) Patent Application Publication
(10) Pub. No.: US 2009/0096580 A1
(43) Pub. Date: Apr. 16, 2009

(54) SECURE AUTHENTICATION

(75) Inventor: Heikki Paananen, Tokyo (JP)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/870,864

(22) Filed: Oct. 11, 2007

(51) Int. Cl. H04Q 5/22

(52) U.S. Cl. 340/10.1

(57) ABSTRACT

A system for automatic identification and/or authentication through a multi-tag communication system. The system may include a plurality of tags which may include devices such as wireless transponders and/or emulated tag devices. Each of the plurality of tags may transmit a portion of identification and/or authentication information to a reader. Each tag alone may transmit insufficient information to identify and/or authenticate a user. The plurality of tags may transmit their respective information in a synchronized fashion to the reader, which may read and process the information to determine whether to grant a user access to a particular secure system or area.

### FIELD OF THE INVENTION

The present invention relates to secured communication. More particularly, the invention is related to a system for electronic identification and/or authentication utilizing secure information obtained synchronously from more than one electronic information source.

### BACKGROUND OF THE INVENTION

Automatic identification and data capture technology is widely used in a number of industries to identify an object or person, collect relevant information, and then store or process this information. Automatic identification systems are commonly implemented in access control systems, security systems and product tracking systems. These systems may include a wide variety of both contact and non-contact technologies. A widely used automatic identification system is the barcode system which was developed in the early 1970s. Similar to barcodes are magnetic strips to hold data that can be read by a reader to identify the card and capture related data. Another automatic identification technology is biometrics, the method of using an intrinsic human trait to identify an individual. Some other automatic identification technologies are optical character recognition, smart cards, as well as voice recognition.

A common wireless technology implemented in automatic identification systems is Radio Frequency Identification (“RFID”). A basic RFID system may consist of an RFID reader and an RFID transponder or tag. The tag can be a microchip or other electronic structure and typically carries information. When an RFID tag is in the proximity of an RFID reader, the RFID reader can wirelessly read information carried by the RFID tag. A data processing system that is in communication with the RFID reader can process the information carried by the RFID tag and utilize it in some useful way, such as to identify the object to which the RFID tag is attached.

RFID may, for example, be implemented in transport payment systems. In such systems, a motorist may have an RFID tag in their automobile. As they pass through a toll station, the RFID reader may read the information in the tag, which a data processing system uses to identify the corresponding motorist who may be billed accordingly. RFID technology may further be implemented as a security measure in access control systems and in security systems. In an exemplary building security system, each employee may have an RFID tag, often implanted into an identification card, and upon presenting the tag to an RFID reader the employee is identified by the data processing system and granted access to an area that is otherwise restricted to the public.

A problem inherent in these basic security systems is that an access card can be easily lost or stolen. In addition, a “third-party” RFID reader can easily access the contents of an RFID tag unbeknownst to the possessor of the tag, which would make it relatively easy for a person with malicious or mischievous intent to copy the information on an RFID tag in order to, for example, make a duplicate tag. Accordingly, current RFID-based security systems are often required to implement supplemental security measures. Supplemental measures often require a user to enter in a pass code or engage in some form of biometric identification in addition to the presentation of a wireless access card in order to improve security. However, these supplemental security measures do not alleviate the fact that an RFID transponder, by itself, is easily readable and does not adequately provide for the secured transmission of identification information.

### SUMMARY OF THE INVENTION

The present invention includes an apparatus, method, program and system for secure and automatic identification and/or authentication through a multi-tag system.

In at least one exemplary application of the invention, a plurality of “tags” may be presented to a reader. These tags may communicate with the reader via wired or wireless communication, and are not limited to devices such as simple wireless transponders, active or passive devices capable of peer to peer communication and/or “emulated” communication devices. Each of the tags may contain a portion of the identification information that a reader could read and interpret to make a positive identification of the user. The plurality of tags may transmit their respective portions of the identification information as load modulated data signals according to a synchronization sequence. The reader may read the synchronized transmissions from the plurality of tags as a single load modulated signal. Moreover, if each tag were to be individually read by a reader, the data signal transmitted would be insufficient to make a positive identification. However, the synchronized transmission of a load modulated data signals from each of the plurality of tags may be read by the reader and a positive identification may be made.

In at least one application of the invention, a plurality of tags may be presented to a reader, wherein each of the tags may contain identical identification information. The identification information contained in the plurality of tags may be masked before transmission. Masking may ensure that an individual tag does not transmit the entire piece of identification information required to positively identify a user. Accordingly, if each masked tag were to be individually read by a reader, the data signal transmitted would be insufficient to make a positive identification. However, the synchronized transmission of the data signals from each of the plurality of masked tags may be read by the reader and a positive identification may be made.

In a further exemplary embodiment of the invention, the plurality of tags may be synchronized according to a synchronization sequence that is transmitted from the reader to the plurality of the tags. The synchronization sequence may also be transmitted from a tag to other tags and/or the reader.

In another example of the invention, the mask used to mask the identification information before transmission may be created using keys. The reader may transmit a key to each of the tags, with which each tag may mask the identification information. The masking key may also be transmitted from one of the tags to the rest of the plurality of tags and/or the reader. In a further embodiment of the invention, the plurality of tags may mask the identification information with a public key shared by the plurality of tags and an internal private key that may be unique to each of the plurality of tags.

In a further exemplary embodiment of the invention, a plurality of dissimilar tags may be presented to a reader. For example, one tag may be a wireless transponder and another tag may be a device capable of peer to peer communication or wireless transponder emulation communication. A device capable of peer-to-peer or transponder emulation communication may include, but is not limited to, a mobile phone including at least a secure memory device and a tag reader. The reader may read identification and/or authentication information transmitted wirelessly by the wireless transponder while also reading identification and/or authentication information stored in the secure memory device. The reader may process both the information received from the wireless transponder and the secure memory device in a synchronized fashion in order to determine whether sufficient identification and/or authentication information has been presented to grant the user access to a secure application or secure information.

### DESCRIPTION OF DRAWINGS

The invention will be further understood from the following detailed description of various exemplary embodiments, taken in conjunction with appended drawings, in which:

FIG. 1 is a structural diagram of an exemplary embodiment of the present invention.

FIG. 2 is an exemplary diagram of a rudimentary RFID reader and transponder.

FIG. 3 is a functional diagram of an exemplary embodiment of the present invention.

FIG. 4 is a flowchart diagramming a communication sequence in accordance with at least one embodiment of the present invention.

FIG. 5 is an activity flow diagram of an exemplary embodiment of the present invention.

FIG. 6 is a structural diagram of an exemplary embodiment of the present invention.

FIG. 7 is an exemplary application of at least one embodiment of the present invention.

FIG. 8 is another exemplary application of at least one embodiment of the present invention.

FIG. 9 is another exemplary application of at least one embodiment of the present invention.

### DESCRIPTION OF THE PREFERRED EMBODIMENT

While the invention has been described in a variety of exemplary embodiments, various changes can be made therein without departing from the spirit and scope of the invention, as described by the appended claims.

The present invention, in at least one embodiment, may be employed in enhancing the security of wireless identification systems. While basic RFID systems will be discussed throughout the specification, the same system may be applied to any wired and/or wireless machine-readable communication technology employing similar communication characteristics. For example, more sophisticated RFID systems may use Near Field Communication (NFC) technology for two way “read-write” communications. NFC is an open platform technology standardized in ECMA-340 and ISO/IEC 18092. These standards specify the modulation schemes, coding, transfer speeds and frame format of the RF interface of NFC devices, as well as initialization schemes and conditions required for data collision-control during initialization-for both passive and active NFC modes. Furthermore, they also define the transport protocol, including protocol activation and data-exchange methods. More information regarding NFC can be found from the website (www.nfc-forum.org). However, it should be noted that the present invention is not limited to RFID technology or NFC technology, which typically operate in the near field region, but may be further configured to include any type of wireless communication devices that operate in the near field or far field region.

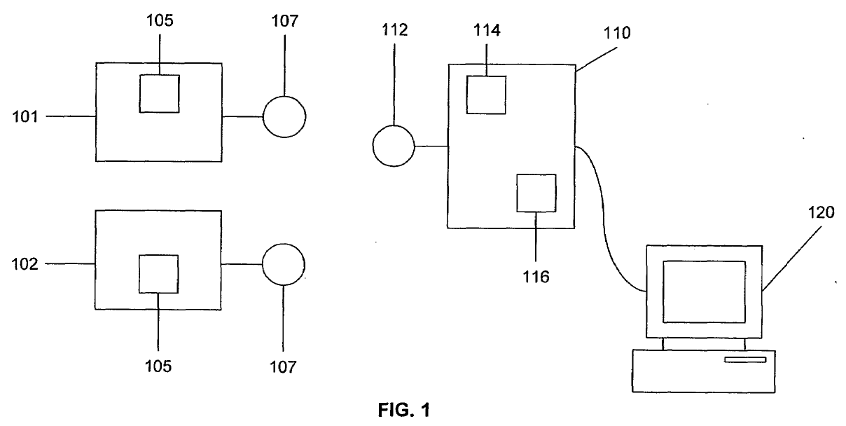

FIG. 1 depicts a structural layout of the identification system according to at least one exemplary embodiment of the invention. The system may include a first tag 101, a second tag 102 and a reader 110. The first tag 101 and second tag 102 may engage in communication with the reader 110, or in at least one embodiment of the present invention, with each other. Either or both of the tags 101, 102 may be wireless transponders as shown, or may be replaced with a RFID device capable of peer-to-peer, or transponder emulation communication. Such an RFID device capable of peer-to-peer or transponder emulation communication may be, but is not limited to, a mobile phone equipped with RFID communication module. In this example, the first tag 101 is a wireless transponder and will be referred to as the first wireless transponder 101. Second tag 102 is also a wireless transponder and will be referred to as second wireless transponder 102. First wireless transponder 101 and second wireless transponder 102 may consist of an integrated circuit 105 that stores data and a coupling element 107 used to communicate with the reader 110 wirelessly via radio frequency communication. The coupling element 107 may be, but is not limited to, a coiled antenna, and may vary depending on the particular wireless communication medium being employed. As set forth above, the multitude of wireless transponders are not limited to communication with the reader but may also be configured to intercommunicate as well. More specifically, first wireless transponder 101 and second wireless transponder 102 may be in wireless communication with each other as well as the reader 110. In addition, the identification system is not limited to a two wireless transponder configuration, but may also be configured to support a multitude of wireless transponders.

The reader 110 may consist of a radio frequency module 114, a control unit 116, and at least one coupling element 112 to interrogate the first wireless transponder 101 and second wireless transponder 102. In some scenarios, the reader 110 may also be configured to engage in communication with a data processing system 120. The data processing system 120 may perform the function of utilizing information that is transmitted from wireless transponders 101 and 102 and read by the reader 110. The data processing system may be, but is not limited to, an application such as a database running on a personal computer that determines whether the user has presented valid identification.

In at least one embodiment of the present invention, both the first wireless transponder 101 and the second wireless transponder 102 may be passive transponders, meaning they have no internal power supply but are powered by the signal sent by the reader 110. In the case of RFID, passive RFID transponders allow RFID readers to read the passive RFID transponder at small to medium distances. Typically, passive transponders obtain their power from the communication signal transmitted by reader 110 through inductive coupling or backscatter coupling. Inductive coupling uses the magnetic field generated by the reader's communication signal to induce a current in the wireless transponder's coupling element 107 similar to a transformer. The current induced in the coupling element 107 produces the voltage and power to operate the transponder. Inductive coupling works primarily in the near field of the communication signal, which is 1/(2π) meters from the signal source. Passive RFID systems designed to work at distances greater than 1/(2π) meters from the signal source commonly implement backscatter coupling.

According to at least one embodiment, either the first wireless transponder 101, or the second wireless transponder 102, or alternatively both of them may also be semi-passive transponders, meaning they include an internal power source to power the integrated circuit 105, but do not use this internal power source to broadcast a signal. Semi-passive transponders broadcast a signal in the same manner as a passive tag, by reflecting the RF energy back to the reader 110. Accordingly, semi-passive RFID transponders can be read at small to medium distances from the RFID reader 110. The aforementioned transponders may also be active, meaning they have an internal power source to power the integrated circuit 105 and transmit a signal. Active transponders allow the RFID reader 110 to read the active transponders at small to large distances, and may read the transponders even if they are located in a hostile environment and/or are obscured from view.

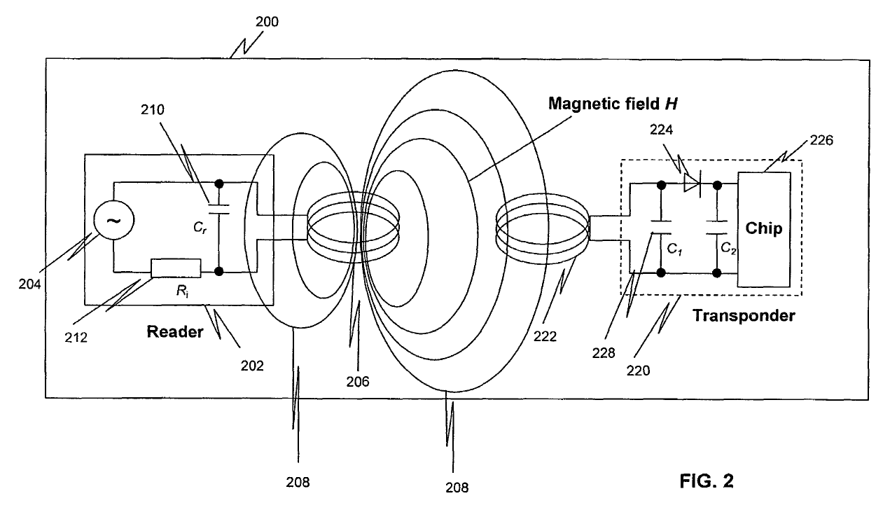

FIG. 2 depicts an exemplary passive RFID reader/transponder system 200, which includes the reader 202 (also known as a scanner) and the transponder 220. The reader 202 includes an AC power source 204 connected to the reader's antenna coil 206, which generates a strong, high frequency electromagnetic field in the area around the reader's antenna coil 206. The strength of the field depends on the power source and the size and number of turns in the coil. The capacitor 210 connected in parallel with the reader's antenna coil 206 and the internal resistance 212 form an RLC oscillator that establishes a resonant circuit with a frequency that corresponds to the transmission frequency of the reader 202. Because the wavelength of the frequency used is several times greater than the close proximity distance between the reader's antenna coil 206 and the transponder's antenna coil 222, the electromagnetic field can be treated as an alternating magnetic field 208. This region of close proximity is linked by their mutual inductance, as in a transformer, with the primary coil being the reader's antenna coil 206 and the secondary coil being the transponder's antenna coil 222. The alternating magnetic field 208 penetrates the transponder's antenna coil 222 when it is in the near field region, inducing an alternating current in the transponder's antenna coil 222. The alternating current is rectified by the diode 224 and serves as the power supply to the RFID microchip 226, which stores the data for the transponder 220.

The transponder's antenna coil 222, the capacitor 228, and the load resistance of the RFID microchip 226 form an RLC oscillator establishing a resonant circuit tuned to the transmission frequency of the reader 202. When the resonant frequency of the transponder 220 corresponds to the transmission frequency of the reader 202, this draws energy from the magnetic field 208. This additional power consumption manifests itself in the reader 202, as a voltage drop across the internal resistance 212 in the reader 202 through the supply current to the reader's antenna coil 206. The RFID microchip 226 represents a variable load resistance to the transponder's antenna coil 222. If the RFID microchip 226 switches its variable load resistance on and off, this changes the resonant frequency of the transponder 220 so that it does not correspond to the transmission frequency of the reader 202, which is then detected as a voltage change across the internal resistance 212 as in the reader 202. In this manner, the RFID microchip 226 can use its stored data to modulate the load resistance on the transponder's antenna coil 222 and transfer its stored data from the transponder 220 to the reader 202. This describes the basic, one-way “listening” function of an RFID system, such as might be used in an identity card to store the user's ID.

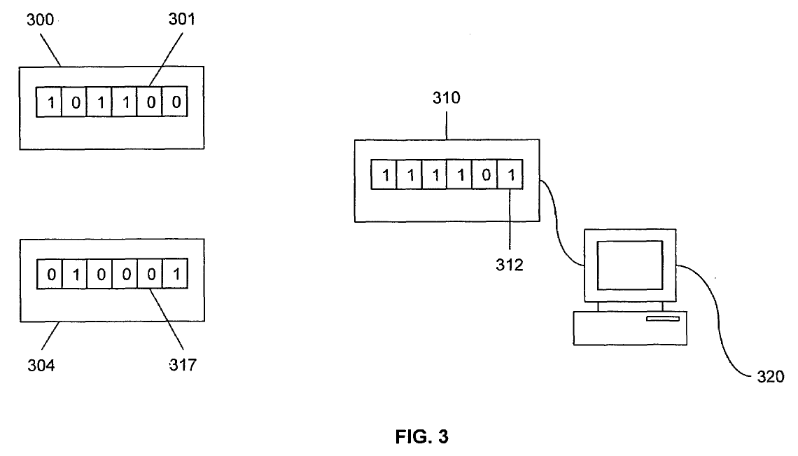

FIG. 3 demonstrates an arrangement for transmitting data from multiple tags comprising multiple wireless transponders to a reader according to an exemplary embodiment of the invention. In this example embodiment, there may be a first wireless transponder 300, and a second wireless transponder 304, and a reader 310, and a data processing system 320. The first wireless transponder 300 and the second wireless transponder 304 may be in wireless communication with the reader 310 and may wirelessly transmit identification information to the reader 310. The reader 310 may read the wirelessly transmitted information and store it as result 312. The reader 310 may be in further communication with a data processing system 320, which may process the result 312, and identify and/or authorize a person in possession of the transponders accordingly. Although FIG. 3 demonstrates an identification system implementing two wireless transponders, the identification system is not limited to this configuration, but may also be configured to support more than two wireless transponders.

In an exemplary embodiment shown in FIG. 3, the first wireless transponder 300 and the second wireless transponder 304 may communicate wirelessly with the reader 310. The transmissions may be, but are not limited to load modulated data signals. In addition, the data signal transmissions of the first wireless transponder 300 and the second wireless transponder 304 may occur in a synchronized manner.

In an exemplary embodiment depicted by FIG. 3, the data processing system 320 may associate a particular user with the string of bits 1-1-1-1-0-1. Accordingly, if result 312 is the string of bits 1-1-1-1-0-1, the user will be positively identified. In this example, the first wireless transponder 300 may contain first content 301, which may consist of the string of bits 1-0-1-1-0-0. The second wireless transponder 304 may contain second content 317 which may consist of the string of bits 0-1-0-0-0-1. If the first wireless transponder 300 was to transmit a data signal consisting only of first content 301 to the reader 310, the data processing system 320 would not be able to make a positive identification of the user. Similarly, if the second wireless transponder 304 was to transmit a data signal consisting only of second content 317, the reader 310 and data processing system 320 would not make a positive identification or authorization of the person in possession of the transponder. However, in an exemplary embodiment of the present invention, the first wireless transponder 300 and the second wireless transponder 304 may transmit first content 301 and second content 317, as load modulated data signals in a synchronized fashion. Doing so would have the effect of executing a wired OR of the two data signals. Reader 310 may then read multiple load modulated signals transmitted in a synchronized fashion as a single load modulated signal. Synchronized transmission of first content 301 which is made up of the bit sequence 1-0-1-1-0-0 and second content 317 which is made up of the bit sequence 0-1-0-0-0-1 may be read by the reader as result 312, the bit sequence 1-1-1-1-0-1. Accordingly, the data processing system 320 may make a positive identification of the user by interpreting these two contents together.

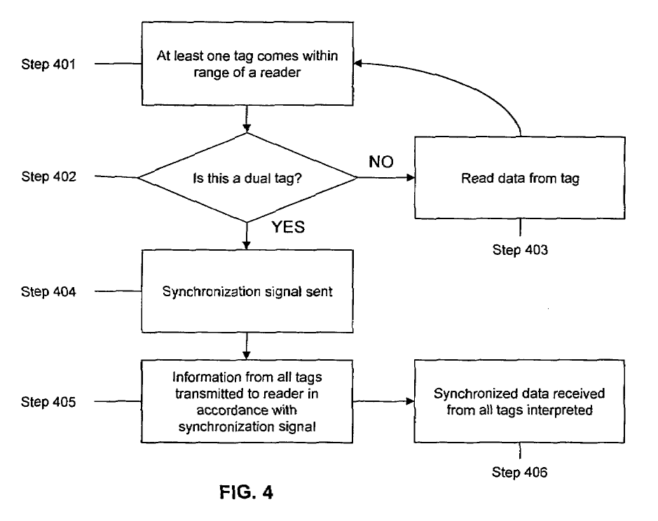

A process in accordance with at least one embodiment of the present invention is explained in FIG. 4. In step 401, at least one wireless transponders (e.g., 101 or 102) may be presented in the range of a reader 110. In step 402, it may be determined whether the at least one transponder is a transponder designed to transmit in conjunction with another transponder. In step 403, if the at least one transponder is not a transponder designed to be read in conjunction with another transponder, it may be read by the reader 110. The process may then return to step 401. In step 404, if the at least one transponder (e.g., 101 or 102) are designed to transmit in conjunction with other transponders, a synchronization signal may be transmitted to the at least one wireless transponders 101 and any other tags in proximity, imbedded in or coupled to the reader 110. This may include actual wireless transponder tags, emulated transponders, memory devices, etc. Synchronization of data signal transmission from the various tags may be achieved in a variety of ways. For example, synchronization may be achieved by transmitting a synchronization sequence from the reader 110 to a first wireless transponder 101 and the second wireless transponder 102, which the first and second wireless transponders 101, 102 use as a reference to time transmission of the data signals. Another way in which the synchronization of data signal transmission may be achieved is by transmitting a signal from the reader 110 to the first wireless transponder 101, which may act as a master wireless transponder. The signal may prompt the first wireless transponder 110 to transmit a synchronization sequence to the second wireless transponder 102, which acts as a secondary wireless transponder. The first wireless transponder 101 and second wireless transponder 102 may use the synchronization sequence as a reference to time transmission of the data signals to the reader 110. It should be further noted that the synchronization sequence may be implemented as a part of the general interrogation signal transmitted from the reader 110 so that the at least one wireless transponders 101, 102 receiving the interrogation signal can immediately adapt according to the synchronization sequence and transmit a response signal in a synchronized manner. The step of synchronization need not be limited to synchronizing two tags (e.g., wireless transponders) but may be used to synchronize more than two tags. In step 405, the at least one wireless transponders (e.g., 101 or 102) may transmit information to the reader 110 in accordance with the synchronization sequence. The at least one wireless transponders 101, 102 may transmit information as load modulated data signals to the reader 110. However, the transmissions are not specifically limited to load modulated data signals. In step 406, the synchronized data signal received by the reader 110 may then be interpreted. Interpreting the data signal may include cross checking the data received with a database of stored identification information to determine whether the data received corresponds to stored identification information.

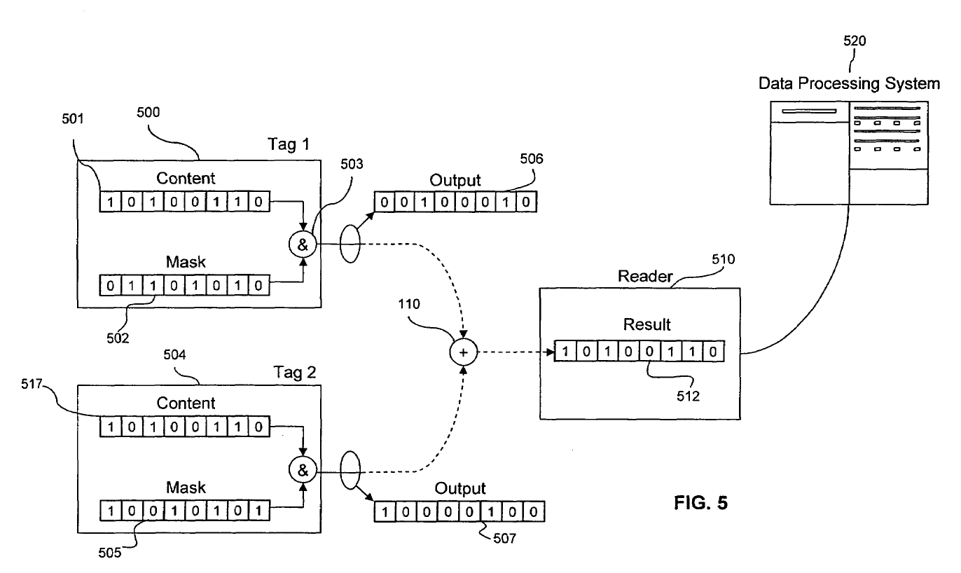

FIG. 5 demonstrates an arrangement for transmitting data from multiple tags, in this scenario wireless transponders, to a reader according to an exemplary embodiment of the invention. In this example there may be a first wireless transponder 500, and a second wireless transponder 504, and a reader 510, and a data processing system 520. Although FIG. 5 demonstrates an identification system implementing two wireless transponders, the identification system is not limited to this configuration, but may also be configured to support a multitude of tags. The first wireless transponder 500 may contain first content 501, and a first mask 502. The second wireless transponder 504 may contain second content 517 and a second mask 505. The first wireless transponder 500 and second wireless transponder 504 may be in wireless communication with the reader 510 and may wirelessly transmit identification information to the reader 510. The reader 510 may read the wirelessly transmitted information and store it as result 512. The reader 510 may further be in communication with a data processing system 520, which may process the result 512, and identify and/or authorize the person in possession of the transponders accordingly.

In the exemplary scenario depicted by FIG. 5, the reader 510 may initiate the communication between the first and second wireless transponders 500, 504 and the reader 510 by transmitting an interrogation signal to the wireless transponders. The interrogation signal may prompt the first and second wireless transponders 500, 504 to begin transmission of identification information and may also power the first and second wireless transponders 500, 504. In addition a synchronization sequence may be implemented as part of the interrogation signal transmitted from the reader 510 so that the first and second wireless transponders 500, 504 may adapt to the synchronization sequence and transmit stored identification information in a synchronized manner. In one exemplary embodiment of the present invention, the interrogation signal may prompt the first wireless transponder 500, which may act as a master transponder, to transmit a synchronization sequence to the second wireless transponder 504, which may act as a secondary wireless transponder. The first and second wireless transponders 500, 504 may use the synchronization use as a reference to time transmission of the data signals to the reader 510.

In the exemplary scenario depicted by FIG. 5, first content 501 may be identical to second content 517. The particular string of bits that make up first and second content 501, 517 is the identification information that, if presented directly to the reader and data processing system, would lead to a positive identification/authorization of the person in possession of the transponders. To enhance the security of the system so that each transponder alone may not transmit sufficient information to identify/authorize a person in possession of the transponders, portions of first and second content 501, 517 may be masked out. The first wireless transponder 500 may mask first content 501 by performing a bitwise AND with the first content 501 and the first mask 502 to create first output 506. Similarly, the second wireless transponder 504 may also perform a bitwise AND of the second content 517 and the second mask 505 to create second output 507. As a result, the first output 506 of first wireless transponder 500 and second output 507 of second wireless transponder 504, if individually read by the reader, would not yield a positive identification of the user.

In this exemplary embodiment, first mask 502 may be the complement of second mask 505, and therefore first content 501 and second content 517 are masked complementarily. As the identical string of bits have been masked in a complementary fashion, performing a bitwise wired OR function on first output 506 and second output 507 would then yield the original string of bits contained in first content 501 and second content 517.

According to an exemplary embodiment of the present invention, a bitwise wired OR function may be achieved by transmitting first output 506 and second output 507, as load modulated signals, in a synchronized fashion. Reader 510 may read the two load modulated signals transmitted in a synchronized fashion as a single load modulated signal, in which the single signal that is read is in actuality a wired OR of the two individual signals transmitted by first wireless transponder 500 and second wireless transponder 504. Accordingly, result 512 would be the same string of bits found in first content 501 and second content 517, and would yield a positive identification of the user.

Although this exemplary embodiment describes a two wireless transponder system wherein the first and second mask 502, 505, are the complement of each other, various masking schemes may be implemented to divide the transmission of identification information amongst a plurality of wireless transponders.

Although the FIG. 5 example depicts a method of securely transmitting identification information from two wireless transponders each containing identical content, first content 501 and second content 517 need not be identical. In such an instance, first content 501 and second content 517 may be distinct as long as the bits with non common data are masked out accordingly. In addition, first and second content 501, 517, and first and second mask 502, 505 need not be fixed strings of bits as depicted in FIG. 5. Wireless transponders, 500 and 504, may be configured to encrypt or decrypt the data using keys. Encryption may be achieved in a variety of ways. For example, Reader 510 may first transmit a public key to first and second wireless transponders 500, 504. First wireless transponder 500 may use the public key, and an internal private key to formulate the first content 501, and first mask 502. Second wireless transponder 504 may also use the public key and an internal private key to formulate second content 517 and second mask 505. Encryption may also be achieved by having the first wireless transponder 500 act as a master transponder, and transmit a public key, which may be read by the second wireless transponder 504 and the reader 510. Second wireless transponder 504 may use the public key transmitted by first wireless transponder 500 and an internal private key to formulate second content 517 and second mask 505. In addition, reader 510 may decrypt the encrypted transmissions of first wireless transponder 500 and second wireless transponder 504 according to the public key initially transmitted by the first wireless transponder 500.

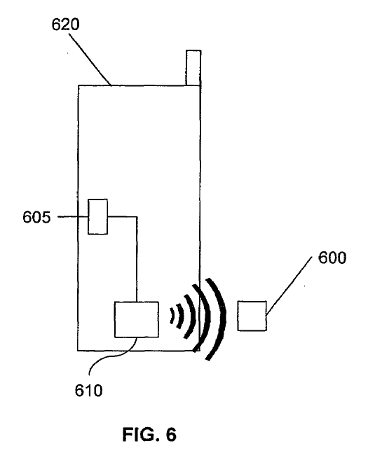

FIG. 6 demonstrates an arrangement for secure information access according to yet another exemplary embodiment of the invention. In this example embodiment the tags may comprise both a wireless transponder 600 and a secure memory device 605 that are accessed by reader 610. The wireless transponder may be configured to be in wireless communication with the reader 610. The secure memory device 605 may be, but is not limited to, a subscriber identity module (“SIM card”) or a secure digital card (“SD card”), and may be configured to be in wired communication with the reader 610. The reader 610 may control access to a secure application or secure information based on the identification and/or authentication information transmitted by the wireless transponder 600 and the secure memory device 605.

According to this exemplary embodiment, the secure memory device 605 may contain secure information, such as a master security key. The wireless transponder 600 may contain secure information such as a second security key. The wireless transponder may only provide a portion of the identification and/or authentication information required by the reader 610 to grant access to the secure application. The other portion of the information required by the reader 610 may be stored in the secure memory device 605. Accordingly, an eavesdropper may not utilize the information accessible via wireless interface. The reader 610 may read the second security key provided by the wireless transponder 600, in a synchronized fashion with the master security key stored in the secure memory device 605. If e.g. the second security key corresponds to the master security key, or alternatively if the second security key and the master security key form a secret, matching with a secret for accessing the secure application or information, the reader may grant access to the secure application or information.

In the exemplary scenario depicted by FIG. 6, the secure memory device 605 and the reader 610 may be located on a device capable of peer-to-peer, or transponder emulation communication. Such a device capable of peer-to-peer or transponder emulation communication may be, but is not limited to, a mobile phone 620. In this application, the mobile phone 620 may run a secure application. The secure application may be, but is not limited to a payment application that requires secure authorization. When a user seeks to access the secure payment application, he may be required to present the wireless transponder 600 to the reader 610 which may also be located on the mobile phone 620. The reader may read the security key contained in the wireless transponder 600. In this exemplary embodiment, only the wireless transponder 600 may be in wireless communication with reader 610. Accordingly, as multiple wireless transmissions do not need to be synchronized, high data rate technology may be implemented to read the wireless transponder 600. The reader 610 may also read the master security key which is stored on the secure memory device 605. The reader 610 may then process the information received from the wireless transponder 600 and the secure memory device information in a synchronized fashion. If the reader determines that the wireless transponder 600 and the secure memory device 605 provide sufficient identification and/or authentication information, the reader may grant the user access to the secure payment application.

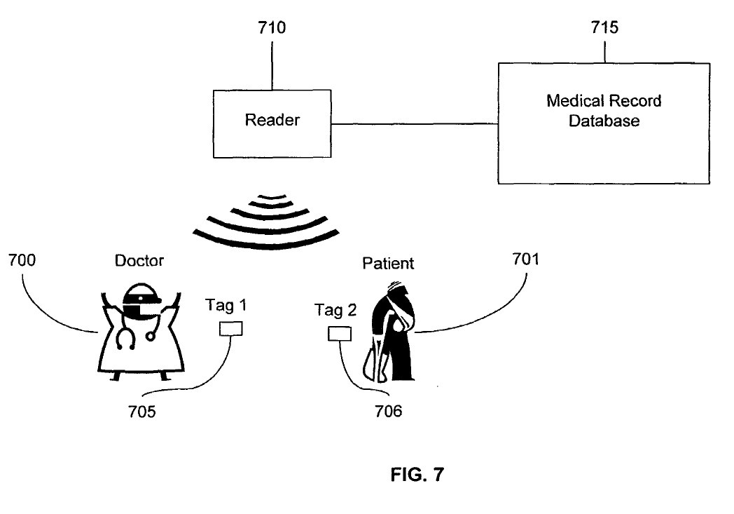

FIG. 7 depicts a possible application in accordance with at least one embodiment of the present invention. This example may be used to secure accessing of personal medical records. In this example there may be a reader 710 in communication with a medical records database 715. A doctor 700 may be in possession of a first tag (e.g., wireless transponder 705), and a patient 701 may be in possession of a second tag (e.g., wireless transponder 706). According to an exemplary embodiment of the present invention, the first wireless transponder 705 or the second wireless transponder 706 when presented to the reader 710 alone, may transmit identification information that is insufficient for the reader 710 to identify the patient 701 and grant access to the privileged medical records. To securely access the records contained in the medical records database 715, the doctor 700 and patient 701 may be required to present the first wireless transponder 705 and second wireless transponder 706 to the reader. The first and second wireless transponders, 705 and 706, may transmit their respective identification information in a synchronized manner as load modulated signals to the reader 710. The reader 710 may receive the synchronized transmission of identification information as a single signal and may determine whether valid identification information has been provided. The reader 710 may then grant or deny access to the medical records database 715 accordingly.

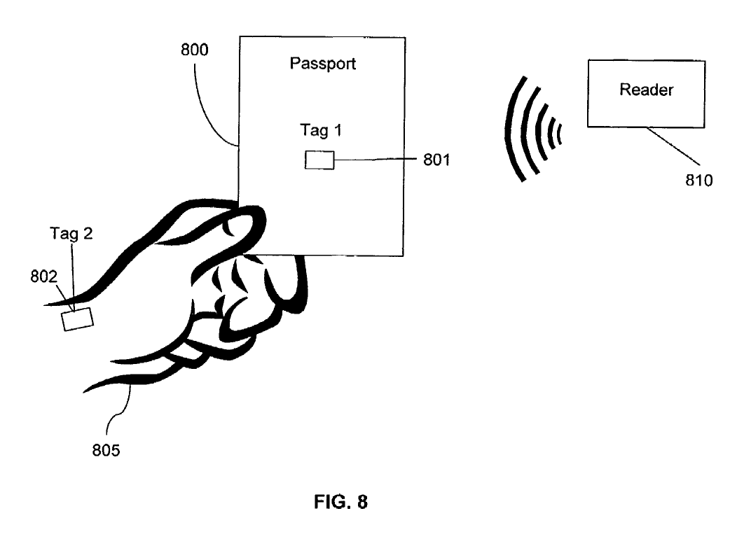

FIG. 8 depicts another exemplary application in accordance with at least one embodiment of the present invention. This example applies to personal identification in security stations such as border crossings. An individual may possess a passport 800, with a first tag (wireless transponder 801) embedded therein. The individual may also have a second tag that is shown as wireless transponder 802 implanted in a body part such as hand 805. The identification information required to positively identify the user may be divided between the first wireless transponder 801 and the second wireless transponder 802. Secure identification of the individual may be achieved by presenting the first wireless transponder 801, found in the passport 800, and the second wireless transponder 802 embedded in his hand 805 to the reader 810. According to the present invention, the first and second wireless transponders 801, 802 may transmit their respective portion of the identification information in a synchronized manner as load modulated data signals to the reader 810. Each signal alone may be insufficient to identify the user. However, the reader 810 may read the synchronized transmission of the identification information transmitted from the first and second wireless transponders 801, 802 as a single signal. The reader 810 may then determine whether sufficient identification information has been presented to make a positive identification of the user.

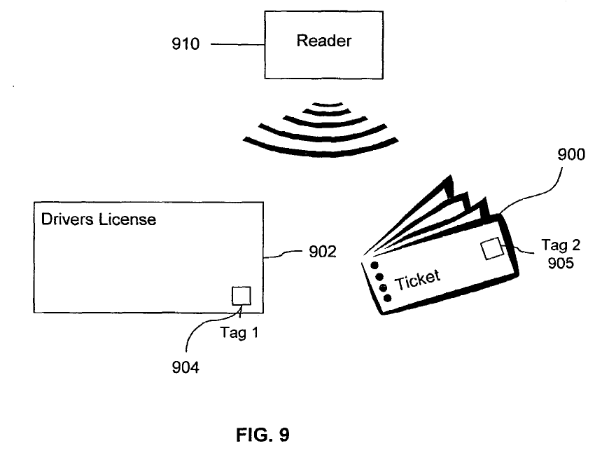

FIG. 9 depicts another exemplary application in accordance with at least one embodiment of the present invention. In this application, a user's drivers license 902 may include a tag such as embedded wireless transponder 904. The user may also be in possession of an admission ticket 900 which may also be embedded with a wireless transponder 905. When the user seeks to gain entrance to the event for which the ticket 900 was purchased, the user may be required to present both ticket 900 and his drivers license 902 in the vicinity of a reader 910. The drivers license wireless transponder 904 and the ticket wireless transponder 905, may communicate wirelessly with the reader 910 in accordance with any of the previously discussed exemplary embodiments of the present invention. As previously described, the ticket stub wireless transponder 905 and the drivers license wireless transponder 804 may each contain only a portion of the information required to positively identify the user. To make a secure identification of the user, the ticket stub wireless transponder 905 and the drivers license wireless transponder 904 may transmit their respective identification information in a synchronized fashion. The reader 910 may receive the synchronized transmissions, and may process the transmissions as a single signal. If the identification information read by the reader 910 is determined to be valid identification information the user may be granted access to the event.

The present invention is not specifically limited to the exemplary embodiments disclosed above, and as a result, may further encompass other configurations. For example, various embodiments of the present invention may include an apparatus comprising means for transmitting a synchronization sequence from a reader to a plurality of tags, means for receiving a data signal in the reader from each of the plurality of tags in accordance with the synchronization sequence, and means for interpreting the combined data signals in the reader as identification information. The apparatus may include at least one of the tags being a wireless transponder that communicates via RFID communication. In addition, the apparatus may include at least one of the tags being emulated by at least one of software or hardware embedded in, or coupled, to the reader device.

Accordingly, it will be apparent to persons skilled in the relevant art that various changes in form and detail can be made therein without departing from the spirit and scope of the invention. The breadth and scope of the present invention should not be limited by any of the above-described exemplary embodiments, but should be defined only in accordance with the following claims and their equivalents.

What is claimed is:

1. A method, comprising:
transmitting a synchronization sequence from a reader to a plurality of tags;
receiving a data signal in the reader from each of the plurality of tags in accordance with the synchronization sequence; and
interpreting the combined data signals in the reader as identification information.

2. The method of claim 1, wherein the received data signal is a load modulated signal.

3. The method of claim 1, wherein at least one of the tags is emulated by at least one of software or hardware embedded in, or coupled, to the reader device.

4. The method of claim 1, wherein the data signal from each of the plurality of tags is masked before transmitting.

5. The method of claim 4, wherein the synchronized transmission of masked content yields the originally unmasked content information when read by the reader.

6. The method of claim 1, wherein the collective transmission of data signals from the plurality of tags yields complete identification information.

7. The method of claim 1, wherein said synchronization sequence is transmitted as a portion of a wireless interrogation signal.

8. A method, comprising:
transmitting a signal from a reader to a plurality of tags, the signal triggering a tag to transmit a synchronization sequence to at least one secondary tag;
receiving a data signal in the reader from each of the plurality of tags in accordance with the synchronization sequence; and
interpreting the combined data signals in the reader as identification information.

9. The method of claim 8, wherein the data signal from each of the plurality of transponders is masked before transmitting.

10. The method of claim 8, wherein the synchronized transmission of the masked content yields the originally unmasked content information when read by the reader.

11. The method of claim 8, wherein the collective transmission of data signals from the plurality of tags yields complete identification information.

12. The method of claim 8, wherein said synchronization sequence is transmitted in response to a wireless interrogation signal.

13. A system, comprising:
a plurality of tags configured to transmit data signals according to a synchronization sequence, and
a reader in communication with the plurality of tags configured for reading the synchronized transmission of data signals and interpreting the data signals as identification information.

14. The system of claim 13, further comprising:
a data processing system in communication with the reader, configured for processing the identification information received by the reader from the plurality of tags.

15. The system of claim 13, wherein the reader is configured for collectively reading the data signals sent by the plurality of tags as identification information.

16. The system of claim 13, wherein at least one of the tags is emulated by at least one of software or hardware embedded in, or coupled, to the reader.

17. The system of claim 13, wherein the reader is configured for transmitting the synchronization sequence.

18. The system of claim 13, wherein one of the plurality of tags is configured for transmitting the synchronization sequence.

19. A computer program product comprising a computer usable medium having computer readable program code embodied in said medium, comprising:
a computer readable program code configured to transmit a synchronization sequence from a reader to a plurality of tags;
a computer readable program code configured to receive a data signal in the reader from each of the plurality of tags in accordance with the synchronization sequence; and
a computer readable program code configured to interpret the combined data signals in the reader as identification information.

20. The computer program product of claim 19, wherein at least one of the tags is emulated by at least one of software or hardware embedded in, or coupled, to the reader device.

21. The computer program product of claim 19, wherein the data signal from each of the plurality of tags is masked before transmitting.

22. The computer program product of claim 19, wherein said synchronization sequence is transmitted as a portion of a wireless interrogation signal.

23. An apparatus comprising:
at least one reader; and
a processor coupled to the reader, the processor further configured to:
transmit a synchronization sequence from the reader to a plurality of tags;
receive a data signal in the reader from each of the plurality of tags in accordance with the synchronization sequence; and
interpret the combined data signals in the reader as identification information.

24. The apparatus of claim 23, wherein at least one of the tags is emulated by at least one of software or hardware embedded in, or coupled, to the reader device.

25. The apparatus of claim 23, wherein said synchronization sequence is transmitted as a portion of a wireless interrogation signal.
